(19) United States
(12) Patent Application Publication
(10) Pub. No.: US 2006/0248132 A1
(43) Pub. Date: Nov. 2, 2006

(54) Information processing apparatus, and method of storing data executed by the same

(75) Inventors: Eiji Tsubono, Nagano (JP); Tatsuya Ichikawa, Nagano (JP); Teruhito Kojima, Nagano (JP); Yasunori Seki, Nagano (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION

(21) Appl. No.: 11/387,961

(22) Filed: Mar. 24, 2006

(30) Foreign Application Priority Data
Mar. 24, 2005 (JP) 2005-085701
Mar. 24, 2005 (JP) 2005-085700
Mar. 24, 2005 (JP) 2005-085699

(51) Int. Cl. G06F 15/02; G06F 15/04

(52) U.S. Cl. 708/130

(57) ABSTRACT

It is detected that a removable storage medium is loaded in an information processing apparatus. Data stored in the storage medium is copied to a storage provided in the apparatus in a case where it is detected that the storage medium is loaded in the apparatus.

### BACKGROUND OF THE INVENTION

This invention relates to an information processing apparatus provided with a storage for storing data and to which a removable storage medium can be loaded. This invention also relates to a method of storing data executed by such an information processing apparatus.

Usually, image data captured by an imaging device such as a digital camera is stored in any of various memory cards provided in the imaging device. To view the image data at high resolution or edit the image data, generally the memory card storing the image data is loaded to an image viewer, a personal computer (PC), etc., capable of displaying the image at high resolution so that the image data is transferred from the memory card as operated by the user.

To transfer the image data from the memory card to the image viewer, the PC, etc. (read) or vice versa (write), it is necessary for the user to enter a transfer command each time. Such a situation is intrusive and inconvenient for the user. Then, to eliminate the intrusive procedure involved in transferring data to the image viewer, the PC, etc. a cradle having a function of transferring stored data in a flash memory to a PC is disclosed in, for example, Japanese Patent Publication No. 2002-209175A.

However, even in the above configuration, an imaging device and its cradle are connected directly and the user needs to display a cradle operation menu screen and select a “data backup” menu, etc., with a pen, etc., and the intrusive procedure for the user still remains unsolved. Particularly, while the user performs necessary operation for transferring the image captured by the imaging device, the user (photographer) loses an opportunity for capturing an image.

### SUMMARY OF THE INVENTION

It is therefore an object of the invention to provide an information processing apparatus (a storage method, and a storage program) for making it possible to transfer data from a memory card to a different information processing apparatus such as an image storage and a display apparatus without performing intrusive operation by the user. It is also an object of the invention to provide a method for storing data executed by such an information processing apparatus.

In order to attain the above described object, according to the invention, there is provided a method for storing data in a storage provided in an information processing apparatus, the method comprising:

detecting that a removable storage medium is loaded in the apparatus; and

copying automatically the data stored in the storage medium to the storage in a case where it is detected that the storage medium is loaded in the apparatus.

The method as set forth in claim 1 may further comprise detecting that the apparatus is activated,

wherein it is automatically detected that the storage medium is loaded in a case where it is detected that the apparatus is activated.

It may be detected that the storage medium is loaded after the apparatus is activated.

The method may further comprise activating the apparatus in a case where it is detected that the storage medium is loaded; and

deactivating automatically the apparatus after the copying of the data is completed.

The method may further comprise notifying at least one of a case where it is detected that the storage medium is loaded, a case where the copying of the data is started and a case where the copying of the data is completed.

The data may include image data.

According to the invention, there is also provided an information processing apparatus comprising:

a storage;

a first detector adapted to detect that a removable storage medium is loaded in the apparatus; and

a copier operable to automatically copy the data stored in the storage medium to the storage in a case where the first detector detects that the storage medium is loaded in the apparatus.

The apparatus may further comprise a second detector operable to detect that the apparatus is activated,

wherein the first detector automatically detects that the storage medium is loaded in a case where the second detector detects that the apparatus is activated.

The first detector may detect that the storage medium is loaded after the apparatus is activated.

The apparatus may further comprise an activator operable to activate the apparatus in a case where the first detector detects that the storage medium is loaded; and

a deactivator operable to deactivate the apparatus automatically after the copying of the data is completed.

The apparatus may further comprise a notifier operable to notify at least one of a case where the first detector detects that a storage medium is loaded, a case where the copying of the data is started and a case where the copying of the data is completed.

The data may include image data.

According to the invention, there is also provided a program medium comprising a storage program which executes a method for storing data in a storage provided in an information processing apparatus, the method comprising:

detecting that a removable storage medium is loaded in the apparatus; and

copying automatically the data stored in the storage medium to the storage in a case where it is detected that the storage medium is loaded in the apparatus.

### BRIEF DESCRIPTION OF THE DRAWINGS

The above objects and advantages of the present invention will become more apparent by describing in detail preferred exemplary embodiments thereof with reference to the accompanying drawings, wherein:

FIG. 1A is a schematic top view of an information processing apparatus according to one embodiment of present invention;

FIG. 1B is a schematic front view of the information processing apparatus shown in FIG. 1A;

FIG. 2 is a block diagram showing a hardware configuration of the information processing apparatus according;

FIG. 3 is a schematic view showing an example of pairs of thumbnail images displayed on a screen;

FIG. 4 is a schematic view showing an example of an initial menu displayed on the screen;

FIG. 5 is a block diagram showing a functional configuration of the information processing apparatus according to a first embodiment of the invention;

FIG. 6 is a flowchart showing a process for storing data in a storage provided in the information processing apparatus according to the first embodiment;

FIG. 7 is a block diagram showing the functional configuration according to a second embodiment of the invention;

FIG. 8 is a flowchart showing a process for storing the data according to the second embodiment;

FIG. 9A is a flowchart showing a process for storing the data according to the second embodiment;

FIG. 9B is a flowchart showing the process for storing the data in combination with the flowchart shown in FIG. 9A;

FIG. 10 is a block diagram showing the functional configuration according to a third embodiment of the invention; and

FIG. 11 is a flowchart showing a process for storing data according to the third embodiment;

### DETAILED DESCRIPTION OF THE EMBODIMENTS

Embodiments of the invention will be discussed in detail with reference to the accompanying drawings.

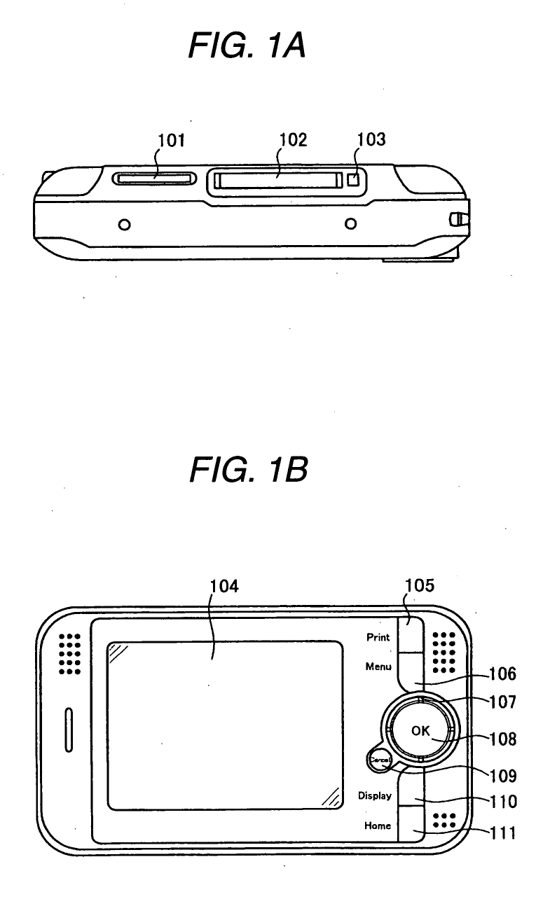

As shown in FIG. 1A, a slot 101 is for loading an SD memory card, an MMC (multimedia card), etc., a slot 102 is for loading a CF card, microdrive, and an eject button 103 is to be pressed by the user to eject the CF card from the slot 102.

As shown in FIG. 1B, a high-resolution liquid crystal monitor 104 (for example, 3.8-inch monitor) is for displaying an operation screen and image data. When the user presses the print button 105 to print an image displayed on the monitor 104, a print setting screen is displayed.

When the user presses a menu button 106, executable operation items are displayed with a pop-up menu, etc. The user can select an item by pressing a 4-way ring 107. To confirm the selection, the user presses an OK button 108. When the user presses a cancel button 109, the operation is canceled and the screen returns to the previous screen page.

When the user presses a display button 110, help for operation and screen information are displayed. When the user presses a home button 111, the operation is canceled and the screen is returned to a “home screen (initial menu screen).”

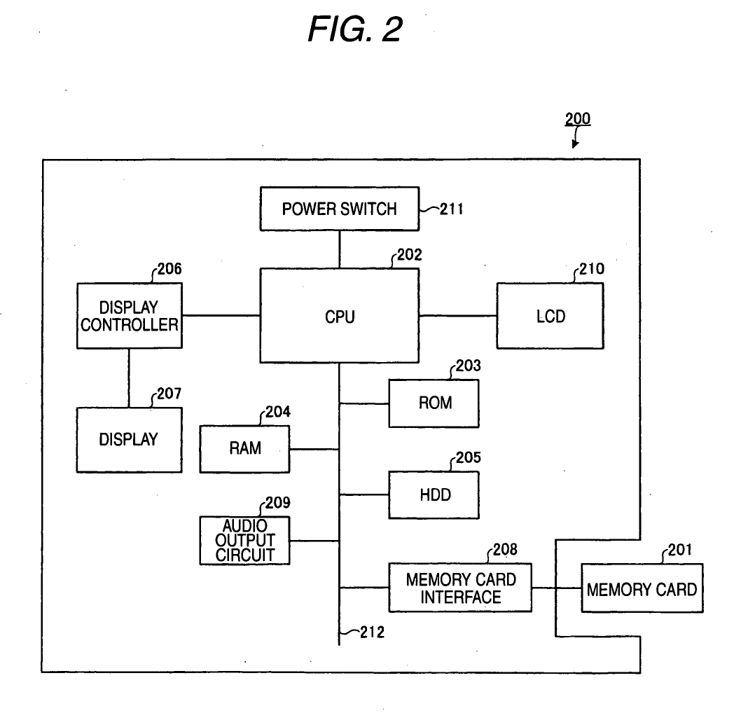

As shown in FIG. 2, an information processing apparatus 200, wherein a memory card 201 can be loaded, comprised a CPU 202, a ROM 203, a RAM 204, an HDD (hard disk drive) 205, a display controller 206, a display 207, a memory card interface 208, an audio output circuit 209, an LCD 210, and a power switch 211. The components 202 to 211 are connected by a bus 212.

The CPU 202 executes programs stored in the ROM 203, the RAM 204, the HDD 205, etc., thereby controlling the whole information processing apparatus 200. The ROM 203 stores a basic processing program of the information processing apparatus 200. The RAM 204 is used as a work area of the CPU 202. The HDD 205 stores various image data and a control program, etc. Storage based ona removable storage medium such as a DVD or a compact disk (CD) may be provided in place of or in addition to the HDD 205.

The display controller 206 controls the screen 207 to perform display control of the image displayed on the screen 207. The screen 207 displays text, an image, etc. The screen 207 specifically is a high-resolution liquid crystal display, etc., for example. The memory card interface 208 controls transferring data between the memory card 201 and the CPU 202 of the information processing apparatus 200. It also detects that the memory card 201 is loaded in and is removed from the information processing apparatus 200.

The audio output circuit 209 outputs audio signals. The LCD 210 emits light, thereby notifying the state of the information processing apparatus 200 or predetermined information (for example, warning information) to the user. When the user turns on the power switch 211, the information processing apparatus 200 is activated and predetermined start operation is executed.

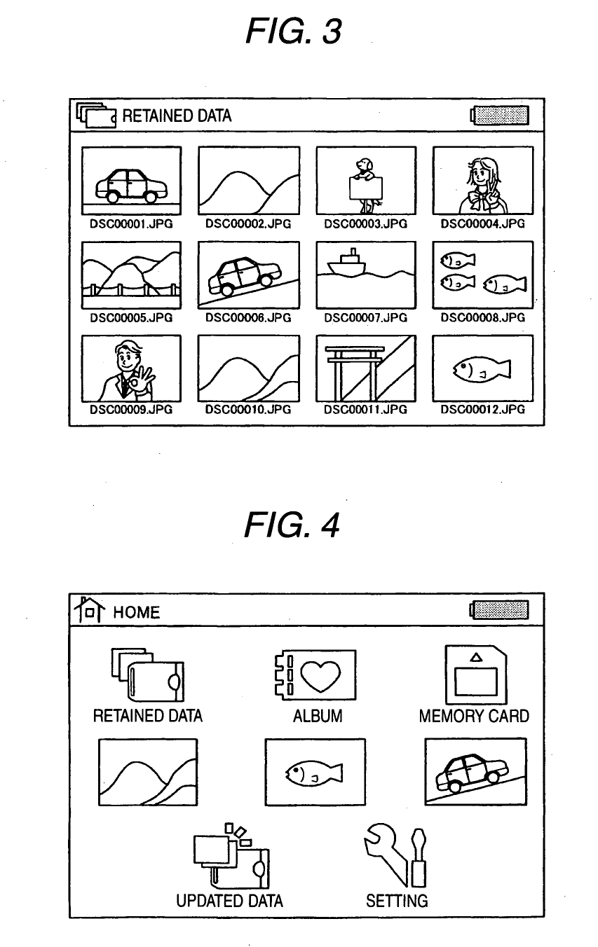

As shown in FIG. 3, pairs of thumbnail images and file names thereof are displayed on the screen 207 in a one-to-one correspondence with files of copied images. Accordingly, the user can recognize that any desired image data is copied without opening the file and can also select easily any desired image data to view or edit an image file.

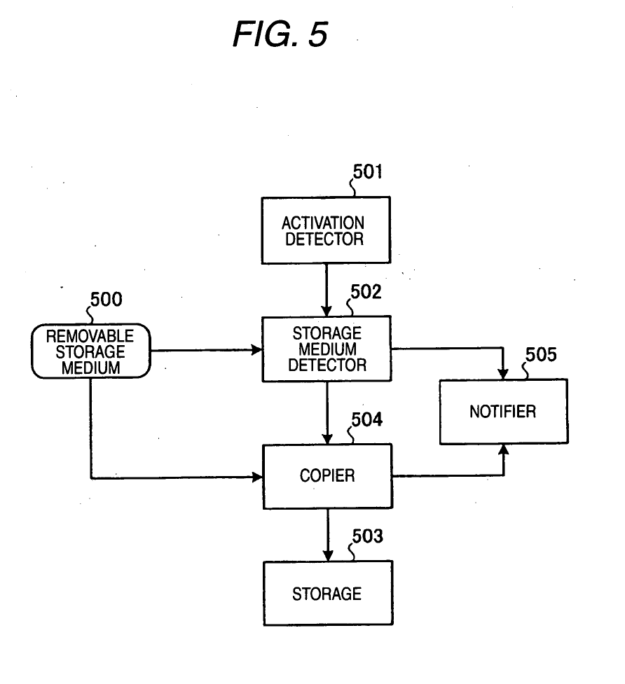

As shown in FIG. 4, the screen 207 displays operable processing buttons (containing icons), waiting for the user to enter a selection command. When the user selects (touches) the icon indicating any desired operation from among the displayed icons, the initial menu screen switches to the selected operation screen.

In this embodiment, when the apparatus is activated, whether or not a memory card 201 exists, namely, is loaded is detected. If the memory card 201 is detected, the image data stored in the memory card 201 is copied to the HDD 205.

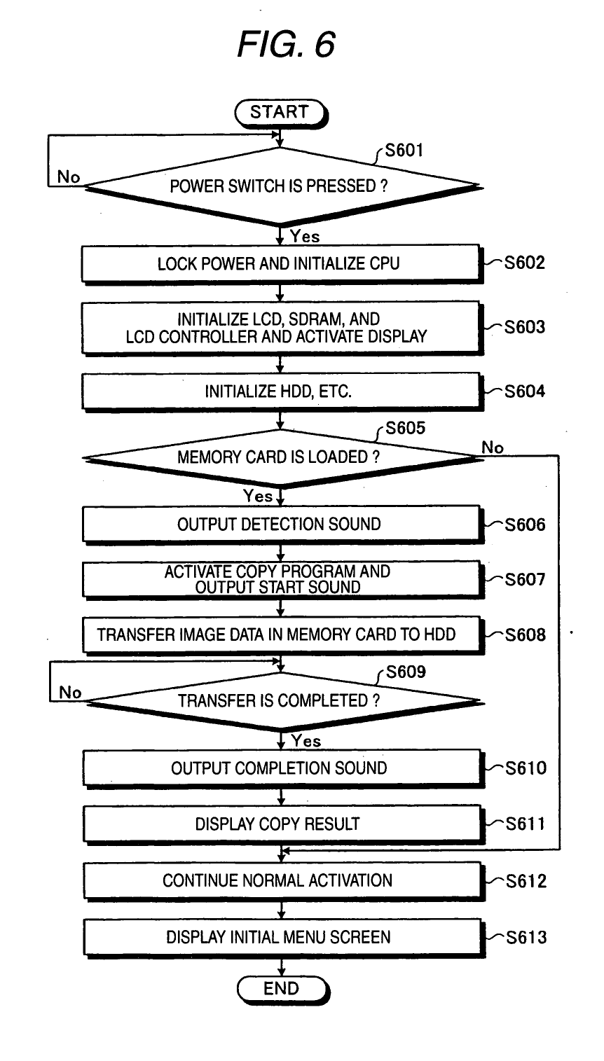

As shown in FIG. 5, the information processing apparatus comprises an activation detector 501, a storage medium detector 502, a storage 503, a copier 504, and a notifier 505.

The activation detector 501 detects that the apparatus is activated. Specifically, the activation detector 501 implements the function, for example, by the power switch 211 shown in FIG. 2 and as the CPU 202 executes the program stored in the ROM 203, the RAM 204, the HDD 205, etc.

When the activation detector 501 detects that the apparatus is activated, the storage medium detector 502 detects that the memory card 201 of a removable storage medium 500 is loaded. Specifically, the storage medium detector 502 implements the function, for example, by the memory card interface 208 shown in FIG. 2 and as the CPU 202 executes the program stored in the ROM 203, the RAM 204, the HDD 205, etc.

The storage 503 stores data, more specifically, image data, for example. The data may be audio data, video data, document data, etc., as well as image data. Specifically, the storage 503 implements the function, for example, by the HDD 205 or the RAM 204.

If the storage medium detector 502 detects that the memory card 201 of the removable storage medium 500 is loaded, the copier 504 copies the data stored in the memory card 201 of the removable storage medium 500 to the storage 503. Specifically, the copier 504 implements the function, for example, as the CPU 202 executes the program stored in the ROM 203, the RAM 204, the HDD 205, etc.

If the storage medium detector 502 detects that the memory card 201 of the removable storage medium 500 is loaded, the notifier 505 provides a notification that the memory card 201 is loaded. If the copier 504 starts copying, the notifier 505 provides a notification that the copier 504 starts copying. If the copier 504 completes copying, the notifier 505 provides a notification that the copier 504 completes copying.

The notifications may be provided by different methods, such as using voice, sound, and predetermined display. At the time, a different notification method (voice, sound, display change, etc.,) may be adopted depending on the notification type (loading detection, copy start detection, or copy completion detection). Specifically, the notifier 505 implements the function, for example, by the display controller 206 and the screen 207, the audio output circuit 209, the LCD 210, etc.

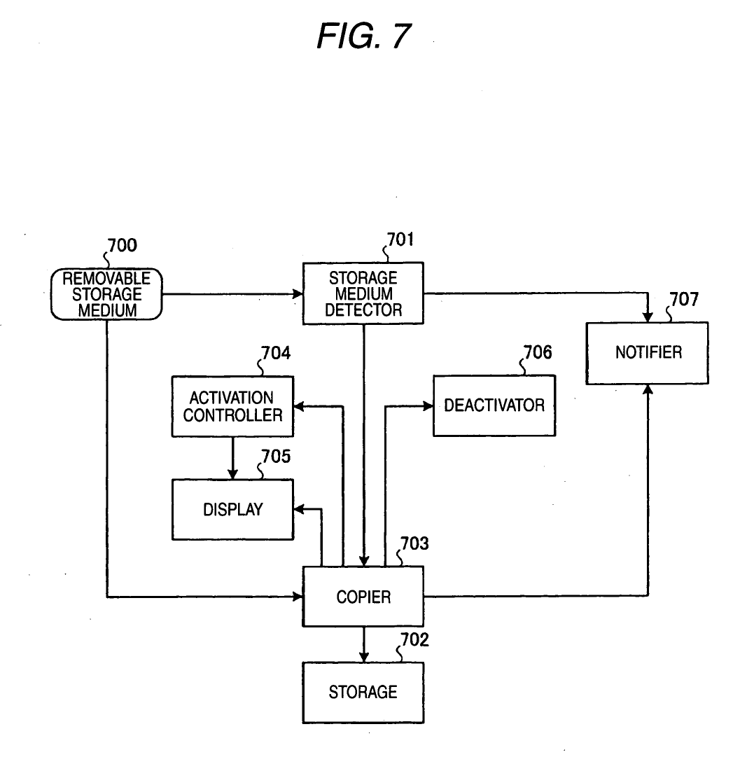

In the flowchart of FIG. 6, first whether or not the power switch 211 is pressed (the SW is ON) is determined (step S601). The information processing apparatus waits for the user to turn on the SW. If the SW is ON (YES at step S601), the power is locked and the CPU 202 is initialized (step S602).

Next, the screen (LCD) 207, the RAM (SDRAM) 204, and the display controller (LCD controller) are initialized and a screen is displayed (step S603). Subsequently, the HDD 205, etc., is initialized (step S604).

Whether or not the memory card 201 exists, namely, is loaded is determined (step S605). If the memory card 201 does not exist (NO at step S605), the process goes to step S612. On the other hand, if the memory card 201 exists (YES at step S605), a detection sound indicating detection of the memory card 201 is output (step S606). Subsequently, a copy program is started and a copy start sound indicating the start of copy is output (step S607).

Next, all image data or specific image data (for example, specified by the image type, the file creation date and time, etc.,) in the memory card 201 is transferred to the HDD 205 through the memory card interface 208 (step S608). Whether or not the transfer is complete is determined (step S609). The information processing apparatus waits for completion of the transfer. It the transfer is complete (YES at step S609), a completion sound indicating completion of the transfer is output (step S610).

The copy result as shown in FIG. 3 is displayed (step S611). Then, at step S612, the normal activation is continued and if the normal activation is complete, the initial menu screen (home screen) as shown in FIG. 4 is displayed (step S613) Accordingly, the information processing apparatus 200 then enters a normal mode for executing normal processing.

With the above configuration, the data can be transferred from the memory card 201 to a different information processing apparatus such as an image storage and display apparatus without performing intrusive operation by the user.

Therefore, the user simply loads the memory card 201 into the information processing apparatus 200 and turns on the power switch 211, whereby the image information stored in the memory card 201 can be transferred to the HDD 205 included in the information processing apparatus 200.

Next, a second embodiment of the invention will be described. Components similar to those in the first embodiment will be designated by the same reference numerals and repetitive explanations for those will be omitted.

In this embodiment, whether or not a memory card 201 has been loaded is detected. If the memory card 201 has been detected, the image data stored in the memory card 201 is copied to the HDD 205. Loading of the memory card 201 may be detected when the apparatus is activated or the normal mode is effected.

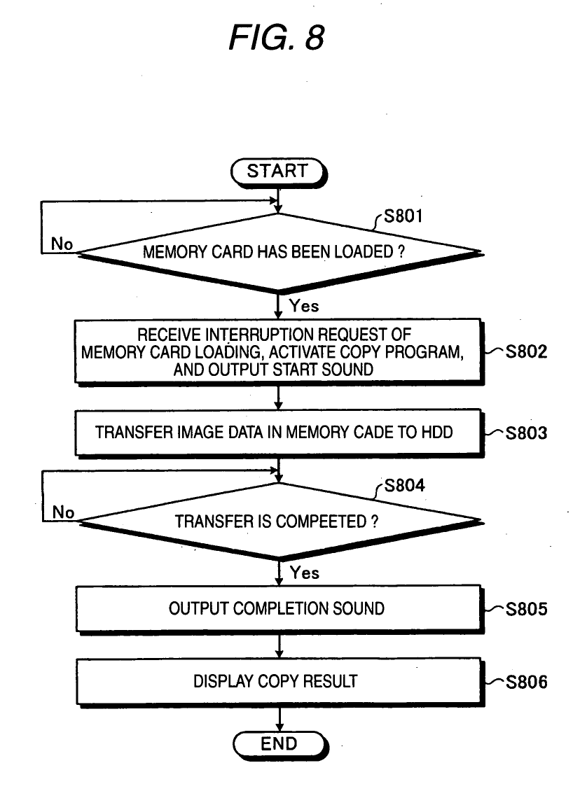

As shown in FIG. 7, the information processing apparatus comprises a storage medium detector 701, a storage 702, a copier 703, a activation controller 704, a display 705, a deactivator 706, and a notifier 707.

The storage medium detector 701 detects that the memory card 201 of a removable storage medium 700 is loaded. Specifically, the storage medium detector 701 implements the function, for example, by the memory card interface 208 shown in FIG. 2 and as the CPU 202 executes the program stored in the ROM 203, the RAM 204, the HDD 205, etc.

The storage 702 stores data, more specifically, image data, for example. The data may be audio data, video data, document data, etc., as well as image data. Specifically, the storage 702 implements the function, for example, by the HDD 205 or the RAM 204.

If the storage medium detector 701 detects that the memory card 201 of the removable storage medium 700 is loaded after the apparatus is activated, the copier 703 copies the data stored in the memory card 201 of the removable storage medium 700 to the storage 702. Specifically, the copier 703 implements the function, for example, as the CPU 202 executes the program stored in the ROM 203, the RAM 204, the HDD 205, etc.

If the storage medium detector 701 detects that the memory card 201 of the removable storage medium 700 has been loaded when the apparatus is activated, the activation controller 704 makes a transition to an initial menu screen display mode after the copier 703 completes copying. Specifically, the activation controller 704 implements the function, for example, as the CPU 202 executes the program stored in the ROM 203, the RAM 204, the HDD 205, etc.

The display 705 displays the copy result as shown in FIG. 3, for example. Specifically, the display 705 implements the function, for example, by the display controller 206 and the screen 207.

If the storage medium detector 701 detects that the memory card 201 of the removable storage medium 700 has been loaded when the apparatus is activated, the deactivator 706 deactivates the apparatus after the copier 703 completes copying. Specifically, the deactivator 706 implements the function, for example, as the CPU 202 executes the program stored in the ROM 203, the RAM 204, the HDD 205, etc.

If the storage medium detector 701 detects that the memory card 201 of the removable storage medium 700 is loaded, the notifier 707 provides a notification that the memory card 201 is loaded. If the copier 703 starts copying, the notifier 707 provides a notification that the copier 703 starts copying. If the copier 703 completes copying, the notifier 707 provides a notification that the copier 703 completes copying. If the storage medium detector 701 does not detect that the memory card 201 of the removable storage medium 700 has been loaded, the notifier 707 provides a notification of requesting the user to load the memory card 201 of the removable storage medium 700.

The notifications may be provided by different methods, such as using voice, sound, predetermined display. At the time, a different notification method (voice, sound, display change, etc.,) may be adopted depending on the notification type (loading detection, copy start detection, or copy completion detection). Specifically, the notifier 707 implements the function, for example, by the display controller 206 and the screen 207, the audio output circuit 209, the LCD 210, etc.

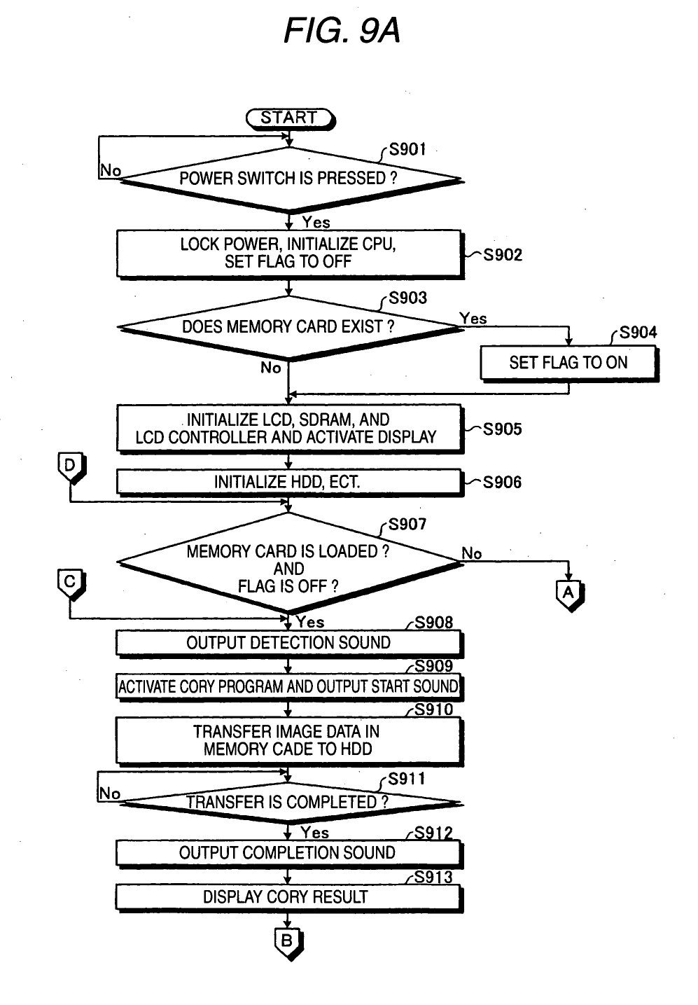

The flowchart of FIG. 8 shows the card loading detection procedure when the normal mode is effected. First, whether or not the memory card 201 has been loaded is determined (step S801).

At step S801, the information processing apparatus waits for the user to load the memory card 201. If the memory card 201 is loaded (YES at step S801), an interrupt request of loading of the memory card 201 is received, a copy program is started, and a copy start sound indicating the start of copy is output (step S802).

Next, all image data or specific image data (for example, specified by the image type, the file creation date and time, etc.,) in the memory card 201 is transferred to the HDD 205 through the memory card interface 208 (step S803). Whether or not the transfer is complete is determined (step S804).

At step S804, the information processing apparatus waits for completion of the transfer. If the transfer is complete (YES at step S804), a completion sound indicating completion of the transfer is output (step S805). The copy result as shown in FIG. 3 is displayed (step S806) and then the successive processing is terminated.

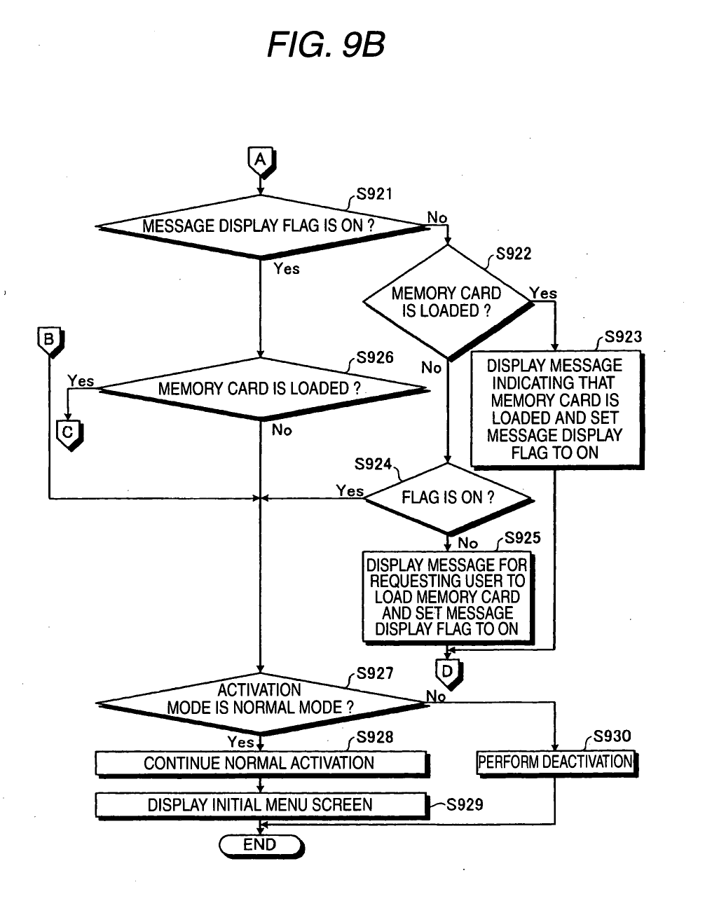

The flowchart of FIG. 9A shows the card loading detection procedure when the apparatus is activated. First, whether or not the power switch 211 is pressed (the SW is ON) is determined (step S901). The information processing apparatus waits for the user to turn on the SW. If the SW is ON (YES at step S901), the power is locked, the CPU 202 is initialized, and a flag indicating the presence or absence of the memory card 201 (simply, the flag) is set to OFF (step S902).

Whether or not the memory card 201 exists, namely, the memory card 201 is loaded in the information processing apparatus 200 is determined (step S903). If the memory card 201 does not exist (NO at step S903), no operation is performed and the process goes to step S905. On the other hand, if the memory card 201 exists (YES at step S903), the flag is set to ON (step S904) and the process goes to step S905.

Next, the screen (LCD) 207, the RAM (SDRAM) 204, and the display controller (LCD controller) are initialized and a screen is displayed (step S905). Subsequently, the HDD 205, etc., is initialized (step S906).

Whether or not the memory card 201 exists (is loaded) and the flag is OFF is determined (step S907). If the memory card 201 exists and the flag is ON, it can be determined that the memory card 201 is not loaded when the apparatus is activated and has been already loaded. Thus, data is not copied.

Therefore, the process goes to step S908 only if the memory card 201 is loaded and the flag is set to OFF (YES at step S907). Otherwise (NO at step S907), specifically (1) if the memory card 201 does not exist and the flag is ON, namely, the memory card 201 is removed during activating apparatus, (2) if the memory card 201 does not exist and the flag is OFF, namely, the memory card 201 does not exist from the beginning, or (3) if the memory card 201 exists and the flag is ON, namely, the memory card 201 exists from the beginning, the process goes to step S921 shown in the flowchart of FIG. 9B. If the memory card 201 is loaded and the flag is OFF (YES at step S907), it means that the card has been loaded for the purpose of copy during a predetermined time period when the apparatus is activated and therefore the process goes to step S908 for performing copy processing.

A detection sound indicating detection of the memory card 201 is output (step S908). Subsequently, the copy program is started and a copy start sound indicating the start of copy is output (step S909).

Next, all image data or specific image data (for example, specified by the image type, the file creation date and time, etc.,) in the memory card 201 is transferred to the HDD 205 through the memory card interface 208 (step S910). Whether or not the transfer is complete is determined (step S911). The information processing apparatus waits for completion of the transfer. If the transfer is complete (YES at step S911), a completion sound indicating completion of the transfer is output (step S912). The copy result as shown in FIG. 3 is displayed (step S913). Then, the process goes to step S927 shown in the flowchart of FIG. 9B.

At step S921 in the flowchart of FIG. 9B, whether or not a message display flag is ON is determined. If the message display flag is OFF (NO at step S921), then whether or not the memory card 201 is loaded (exists) is determined (step S922).

If the memory card 201 exists at S922 (YES at step S922), a message that the memory card 201 is loaded is displayed on the screen 207 and the message display flag is set to ON (step S923). The message that the memory card 201 is loaded is specifically, for example, a message of “There is a possibility that a memory card may be left entered. To copy the data on the memory card, press “confirm” button (not shown). Not to copy, remove the memory card and then press “confirm” button.” or the like. The “confirm” button (not shown) is displayed together with the message. The information processing apparatus waits for the user to press the “confirm” button. When the user presses the “confirm” button, the process returns to step 5907 shown in FIG. 9A.

If the memory card 201 does not exist at S922 (NO at S922), then whether or not the flag is ON is determined (step S924). If the flag is ON (YES at step S924), it can be determined that the memory card 201 is removed during activating the apparatus, and then the process goes to step S927. On the other hand, if the flag is OFF at step S924 (NO at step S924), a message for requesting the user to load the memory card 201 is displayed on the screen 207 and the message display flag is set to ON (step S925). Then, the process returns to step S907 shown in FIG. 9A.

If the message display flag is ON at step S921 (YES at step S921), then whether or not the memory card 201 exists is determined (step S926). If the memory card 201 exists (YES at step S926), it is determined that the user wants to copy the data in the memory card 201, and the process goes to step S908 shown in FIG. 9A. In contrast, if the memory card 201 does not exist (NO at S926), it is determined that the user does not want to copy the data in the memory card 201, and the process goes to step S927.

At step S927, whether or not the activating mode is the normal mode is determined. If the activating mode is the normal mode (YES at step S927), the normal activation is continued (step S928) and when the normal activation is complete, the initial menu screen (home screen) as shown in FIG. 4 is displayed (step S929). Accordingly, the information processing apparatus 200 then enters the normal mode for executing normal processing.

If the activating mode is a deactivating mode rather than the normal mode at step S927 (NO at step S927), shutdown processing is performed (step S930) and the successive processing is terminated.

With the above configuration, the data can be transferred from the memory card 201 to a different information processing apparatus such as an image storage and display apparatus without performing intrusive operation by the user.

Therefore, the user simply turns on the power switch 211 and loads the memory card 201 into the information processing apparatus 200, whereby the image information stored in the memory card 201 can be transferred to the HDD 205 included in the information processing apparatus 200.

Next, a third embodiment of the invention will be described. Components similar to those in the first embodiment will be designated by the same reference numerals and repetitive explanations for those will be omitted.

In this embodiment, whether or not a memory card 201 has been loaded is detected when the information processing apparatus 200 is deactivated. If the memory card 201 is detected, the information processing apparatus 200 is activated and the image data stored in the memory card 201 is copied to the HDD 205. After completion of the copying, immediately deactivation is executed and the apparatus is deactivated.

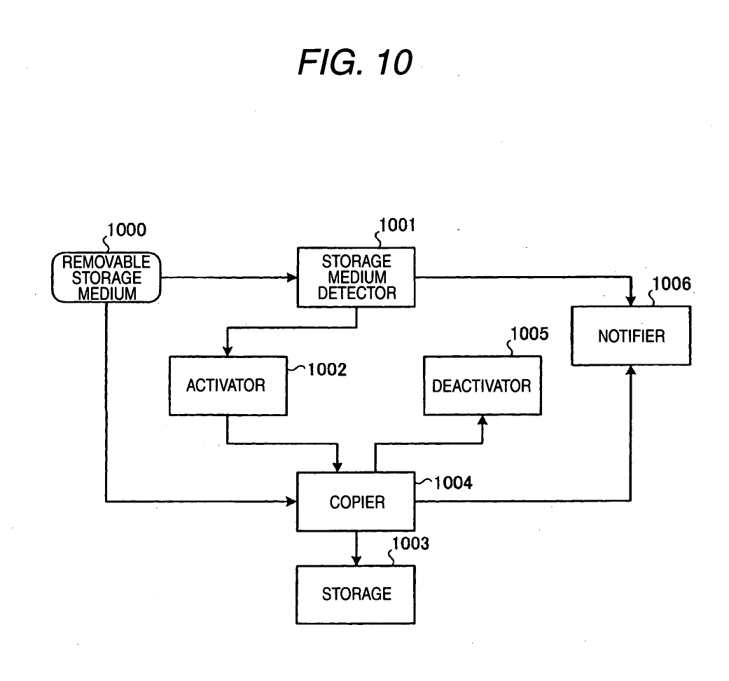

As shown in FIG. 10, the information processing apparatus comprises a storage medium detector 1001, an activator 1002, a storage 1003, a copier 1004, a deactivator 1005, and a notifier 1006.

The storage medium detector 1001 detects that the memory card 201 of a removable storage medium 1000 is loaded. Specifically, the storage medium detector 1001 implements the function, for example, by the memory card interface 208 shown in FIG. 2 and as the CPU 202 executes the program stored in the ROM 203, the RAM 204, the HDD 205, etc.

If the storage medium detector 1001 detects that the memory card 201 of the removable storage medium 1000 has been loaded, the activator 1002 activates the apparatus. The activator 1002 implements the function, for example, by the memory card interface 208 shown in FIG. 2 and as the CPU 202 executes the program stored in the ROM 203, the RAM 204, the HDD 205, etc.

The storage 1003 stores data, more specifically, image data, for example. The data may be audio data, video data, document data, etc., as well as image data. Specifically, the storage 1003 implements the function, for example, by the HDD 205 or the RAM 204.

After the activator 1002 activates the apparatus, the copier 1004 copies the data stored in the memory card 201 of the removable storage medium 1000 to the storage 1003. Specifically, the copier 1004 implements the function, for example, as the CPU 202 executes the program stored in the ROM 203, the RAM 204, the HDD 205, etc.

The deactivator 1005 deactivates the apparatus after the copier 1004 completes copying. Specifically, the deactivator 1005 implements the function, for example, as the CPU 202 executes the program stored in the ROM 203, the RAM 204, the HDD 205, etc.

If the storage medium detector 1001 detects that the memory card 201 of the removable storage medium 1000 is loaded, the notifier 1006 provides a notification that the memory card 201 is loaded. If the copier 1004 starts copying, the notifier 1006 provides a notification that the copier 1004 starts copying. If the copier 1004 completes copying, the notifier 1006 provides a notification that the copier 1004 completes copying.

The notifications may be provided by different methods, such as using voice, sound, and predetermined display. At the time, a different notification method (voice, sound, display change, etc.,) may be adopted depending on the notification type (loading detection, copy start detection, or copy completion detection). Specifically, the notifier 1006 implements the function, for example, by the display controller 206 and the screen 207, the audio output circuit 209, the LCD 210, etc.

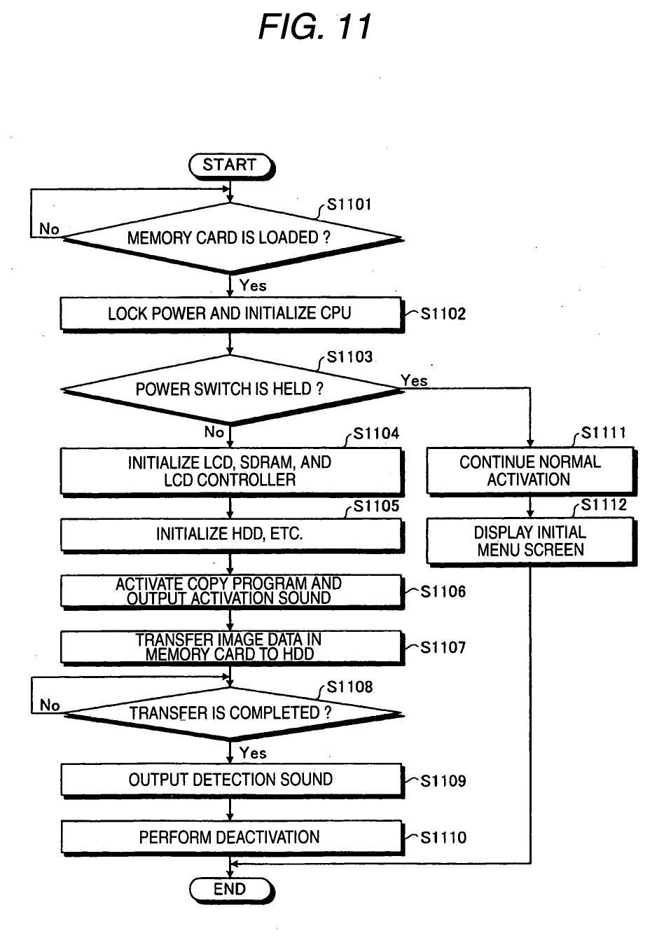

In the flowchart of FIG. 11, first, whether or not the memory card 201 has been loaded is determined (step S1101). At step S1101, the information processing apparatus waits for the user to load the memory card 201. If the memory card 201 has been loaded (YES at step S1101), the power is locked and the CPU 202 is initialized (step S1102).

Whether or not the power switch 211 is held, namely, whether or not the user turns on the power switch 211 is determined (step S1103). If the power switch 211 is not held (NO at step S1103), then the screen (LCD) 207, the RAM (SDRAM) 204, and the display controller (LCD controller) are initialized (step S1104). Subsequently, the HDD 205, etc., is initialized (step S1105).

A copy program is started and a copy start sound indicating the start of copy is output (step S1106). Next, all image data or specific image data (for example, specified by the image type, the file creation date and time, etc.,) in the memory card 201 is transferred to the HDD 205 through the memory card interface 208 (step S1107).

Next, whether or not the transfer is complete is determined (step S1108). The information processing apparatus waits for completion of the transfer. If the transfer is complete (YES at step S1108), a completion sound indicating completion of the transfer is output (step S1109). Then, the copy program is completed, shutdown processing is performed (step S1110), and the successive processing is terminated.

If the power switch 211 is held at step S1103 (YES at step S1103), the normal activation is continued (step S1111) and when the normal activation is complete, the initial menu screen (home screen) as shown in FIG. 4 is displayed (step S1112). Accordingly, the information processing apparatus 200 then enters the normal mode for executing normal processing.

With the above configuration, the data can be transferred from the memory card 201 to a different information processing apparatus such as an image storage and display apparatus without performing intrusive operation by the user.

Therefore, the user simply loads the memory card 201 into the information processing apparatus 200 without turning on the power switch 211, whereby the image information stored in the memory card 201 can be transferred to the HDD 205 included in the information processing apparatus 200 and the apparatus can also be deactivated. Therefore, power storing can be accomplished.

The storage method in each of the embodiments may be a computer-readable, provided program and is implemented as the program executed in a computer, such as a personal computer or a workstation including a server. The program is stored in a computer-readable storage medium such as an HD, FD, CD-ROM, MO, or DVD and is read by a computer from the storage medium, whereby the program is executed. The program may be a transmission medium that can be distributed through a network such as the Internet. The invention is suited to an information processing apparatus such as a portable (mobile) image storage and display apparatus.

What is claimed is:

1. A method for storing data in a storage provided in an information processing apparatus, the method comprising:
detecting that a removable storage medium is loaded in the apparatus; and
copying automatically the data stored in the storage medium to the storage in a case where it is detected that the storage medium is loaded in the apparatus.

2. The method as set forth in claim 1 further comprising detecting that the apparatus is activated,
wherein it is automatically detected that the storage medium is loaded in a case where it is detected that the apparatus is activated.

3. The method as set forth in claim 1, wherein it is detected that the storage medium is loaded after the apparatus is activated.

4. The method as set forth in claim 1 further comprising:
activating the apparatus in a case where it is detected that the storage medium is loaded; and
deactivating automatically the apparatus after the copying of the data is completed.

5. The method as set forth in claim 1 further comprising notifying at least one of a case where it is detected that the storage medium is loaded, a case where the copying of the data is started and a case where the copying of the data is completed.

6. The method as set forth in claim 1, wherein the data includes image data.

7. An information processing apparatus comprising:
a storage;
a first detector adapted to detect that a removable storage medium is loaded in the apparatus; and
a copier operable to automatically copy the data stored in the storage medium to the storage in a case where the first detector detects that the storage medium is loaded in the apparatus.

8. The apparatus as set forth in claim 7 further comprising a second detector operable to detect that the apparatus is activated,
wherein the first detector automatically detects that the storage medium is loaded in a case where the second detector detects that the apparatus is activated.

9. The apparatus as set forth in claim 7, wherein the first detector detects that the storage medium is loaded after the apparatus is activated.

10. The apparatus as set forth in claim 7 further comprising:
an activator operable to activate the apparatus in a case where the first detector detects that the storage medium is loaded; and
a deactivator operable to deactivate the apparatus automatically after the copying of the data is completed.

11. The apparatus as set forth in claim 7 further comprising a notifier operable to notify at least one of a case where the first detector detects that a storage medium is loaded, a case where the copying of the data is started and a case where the copying of the data is completed.

12. The apparatus as set forth in claim 7, wherein the data includes image data.

13. A program medium comprising a storage program which executes a method for storing data in a storage provided in an information processing apparatus, the method comprising:
detecting that a removable storage medium is loaded in the apparatus; and
copying automatically the data stored in the storage medium to the storage in a case where it is detected that the storage medium is loaded in the apparatus.
